(19) United States
(12) Patent Application Publication
(10) Pub. No.: US 2008/0097873 A1
(43) Pub. Date: Apr. 24, 2008

(54) SYSTEM FOR ONLINE TRAVEL PLANNING AND HOTEL SELECTION

(76) Inventors: Elliot Cohen, Raanana (IL); Yotam Luz, Burgata (IL)

Correspondence Address: DEBRA HAKIMIAN, SIMTAT HAMACABIM 8, RAANANA, IL

(21) Appl. No.: 11/758,120

(22) Filed: Jun. 5, 2007

Related U.S. Application Data
(60) Provisional application No. 60/803,880, filed on Jun. 5, 2006.

(51) Int. Cl. G06Q 30/00; G06Q 50/00

(52) U.S. Cl. 705/27; 705/26

(57) ABSTRACT

A method for travel planning employing a computerized database query system, the method including user designation of at least one desired travel destination and system presentation to user of at least one proposed hotel, based on the user designation, the at least one proposed hotel in geographical proximity to or otherwise convenient to said travel destination.

### REFERENCE TO RELATED APPLICATIONS

Reference is made to U.S. Provisional Patent Application Ser. No. 60/803,880, filed Jun. 5, 2006 and titled Online Interactive Travel System with Proximity-Based Hotel Searching, the disclosure of which is hereby incorporated by reference and priority of which are hereby claimed pursuant to 37 CFR 1.78(a) (4) and (5)(i).

### FIELD OF THE INVENTION

The present invention relates generally to systems and methodologies for interactive travel planning and hotel searching more particularly to computer-network based systems and methodologies for travel planning as well as computer-based methods and apparatus for creating such systems and methodologies.

### BACKGROUND OF THE INVENTION

The following U.S. Patent Publications, the disclosures of which are hereby incorporated by reference, are believed to represent the current state of the art:

U.S. Pat. Nos. 6,282,489; 6,993,430; 6,801,226 and 6,295,521; and

U.S. Patent Application Publication Nos. 2006/0271277; 2006/0287810; 2005/0021424 and 2005/0216301.

### SUMMARY OF THE INVENTION

The present invention seeks to provide improved computer-network based systems and methodologies for travel planning and hotel searching as well as computer-based methods and apparatus for creating such systems and methodologies.

In accordance with a preferred embodiment of the present invention the method also includes system presentation to a user of at least one proposed hotel, with the at least one proposed hotel selected for presentation based on general convenience to a selected travel destination.

In accordance with a preferred embodiment of the present invention the method also includes system presentation to user comprising a visually sensible graphical map of the proposed travel destination bearing visually sensible indicia corresponding to proposed hotels generally convenient to said travel destination.

In accordance with a preferred embodiment of the present invention the method also includes user designation of amenities and system presentation of visually sensible indicia corresponding to user-designated amenities and generally convenient to the travel destination.

In accordance with a preferred embodiment of the present invention the method also includes system a prepared set of possible desired travel parameters, available for designation by users user in order to characterize a travel destination.

In accordance with a preferred embodiment of the present invention the method also includes at least one proposed hotel which is selected at least partially to correspond to the desired travel parameters of said travel destination. Preferably, the at least one proposed hotel is characterized by at least one parameter. According to one embodiment of the present invention, the characterizing parameter is user reviews.

In accordance with another preferred embodiment of the present invention a system for travel planning comprises a graphical user interface operative to enable user designation of at least one desired travel destination. The system for travel planning preferably further comprises an interactive computer system responsive to the user designation of a desired travel destination for selecting at least one generally convenient proposed hotel relative to the desired travel destination; and a display presenting to said user in visually sensible form said at least one proposed hotel.

In accordance with another preferred embodiment of the present invention, a method for constructing a system for travel planning includes a graphical user interface operative to enable user designation of at least one desired travel destination, and an interactive computer system responsive to the user designation for indicating at least one proposed hotel; and a display presenting to the user in visually sensible form said at least one proposed hotel. Preferably, the method comprises the steps of designating a plurality of desired travel destinations, designating a plurality of hotels, selecting a multiplicity of proposed hotels in proximity thereof, preparing information relating to at least one of the multiplicity of proposed hotels for presentation to a user on a display in visually sensible form.

In accordance with another preferred embodiment of the present invention the method also includes filtering of the multiplicity of proposed hotels based on convenience factors. Preferably the convenience factors include geographical considerations. The convenience factors may also include traffic or road considerations.

In accordance with another preferred embodiment of the present invention the method also includes the filtering of the multiplicity of proposed hotels based on ranking factors. Preferably, the ranking factors include reviews from at least one external user.

### BRIEF DESCRIPTION OF THE DRAWINGS

The present invention will be understood and appreciated more fully from the following detailed description, taken in conjunction with the drawings in which:

FIGS. 1A-1C are together a simplified illustration of the operation of a preferred embodiment of the present invention;

FIGS. 2A-2D are exemplary screen shots illustrating a computer screen as seen by a user at various stages of operation of the present invention;

FIG. 3 is a simplified illustrative diagram of an algorithm employed in accordance with one embodiment of the present invention.

### DETAILED DESCRIPTION OF A PREFERRED EMBODIMENT

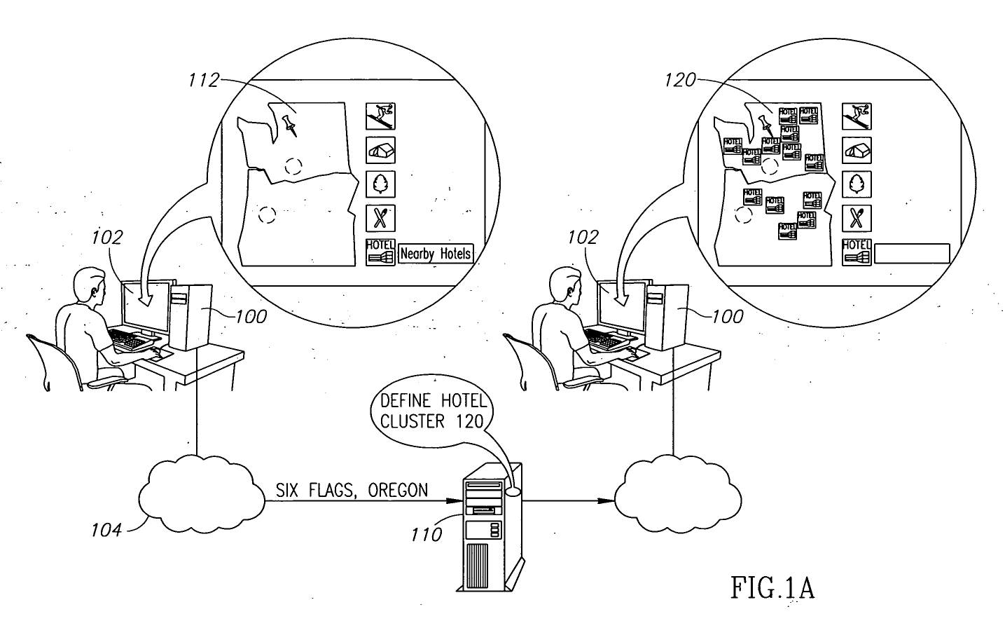

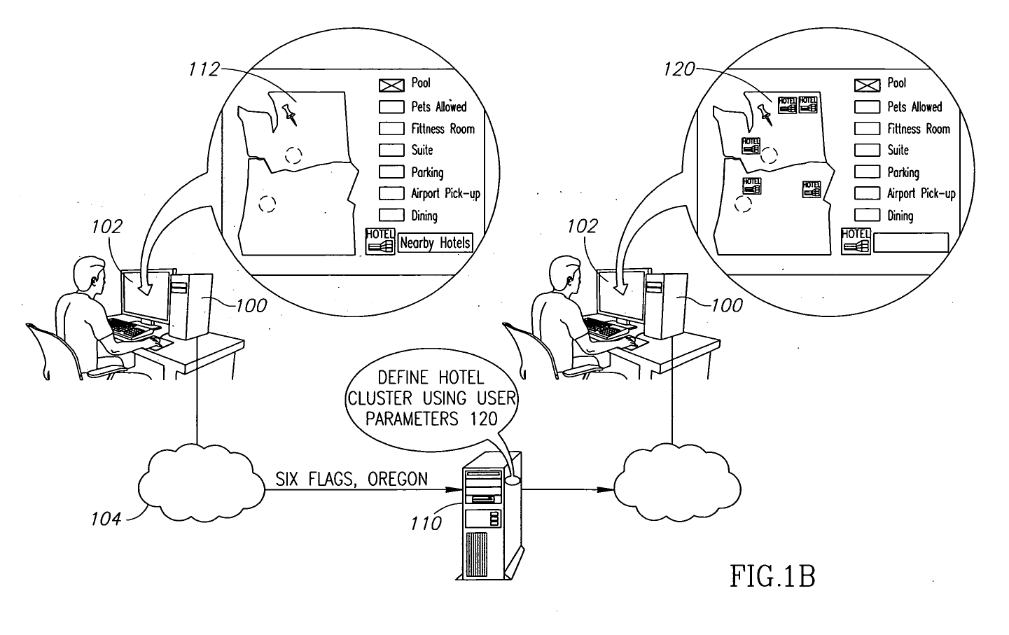

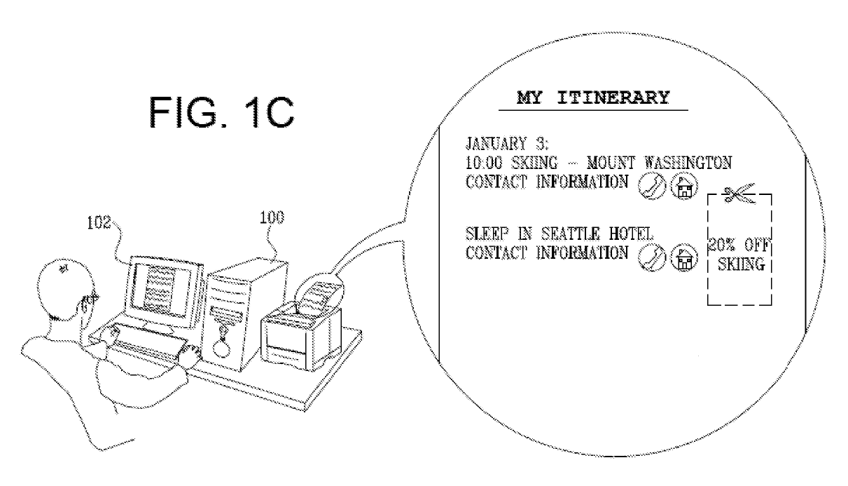

Reference is now made to FIG. 1A, which illustrates operation of a system for travel planning including a graphical user interface 100, such as any conventional Internet compatible computer including a display 102, operative to enable user selection of at least one desired travel destination and further operative to enable indication of a cluster of hotels located in geographical proximity or otherwise convenient to the travel destination. Normally the system is configured for simultaneous communication with a multiplicity of such computers via the Internet 104.

An interactive computer system 110, typically embodied in one or more servers located remotely from the graphical user interfaces 100, is responsive to user selection of at least one proposed travel destination 112, and to indicate a cluster of hotels convenient thereto. Convenience factors preferably include geographies and may further include accessibility, rankings based on user opinions, hotel popularity, and bookability. Although a client-server type of architecture is primarily envisioned, it is appreciated that any other suitable type of architecture may be employed.

Desired travel destinations 112 may be of various types and may include tourist attractions, amusement parks, museums, zoos, national parks, airports or other places or sites of interest.

In accordance with a preferred embodiment of the present invention, responsive to the user's selection of a specific travel destination 112 using a graphical user interface 100, the interactive computer system 110 designates a cluster including one or more generally nearby hotels 120 and displays them on display 102.

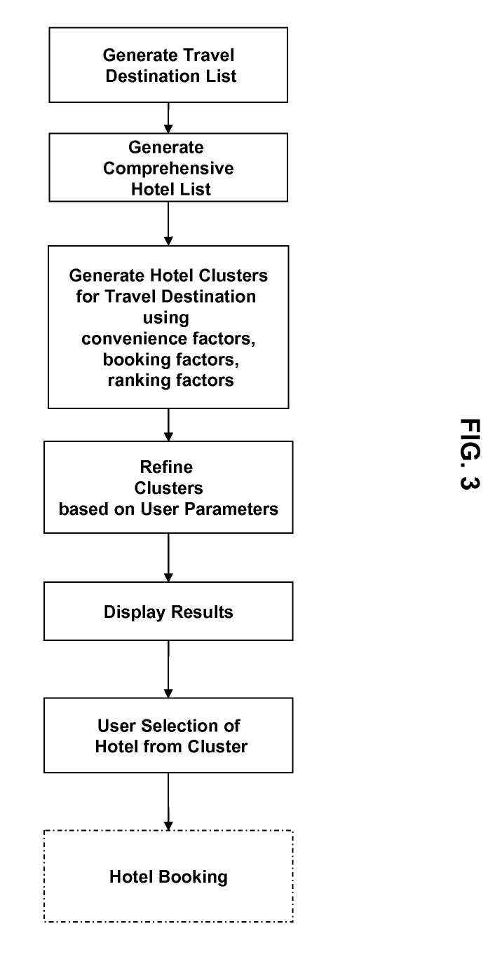

In accordance with one preferred embodiment of the present invention, the cluster of hotels 120 represent hotels generally convenient to the travel destination 112 or otherwise suitable or relevant to the travel destination and as designated by an algorithm such as the algorithm described in FIG. 3.

It may be seen in FIG. 1A that when a user designates SIX FLAGS, OREGON as a desired travel destination 112, the user is presented with a cluster of hotels 120. A designation of CASCADE MOUNTAINS and selection of a request to show nearby hotels results in a display of a cluster of hotels which may be at least partially different from the cluster of hotels 120 resulting from a designation of SIX FLAGS OR. In accordance with one preferred embodiment of the present invention, a cluster of hotels displayed near an amusement park may be different than a cluster of hotels displayed near an art museum located in geographic proximity to the amusement park. For example, the cluster of hotels displayed near an amusement park may include a greater number of family friendly hotels while the cluster of hotels displayed near a museum may include more luxury and upscale hotels.

According to an alternative embodiment of the present invention, depicted generally in FIG. 1B, hotels included in the cluster of hotels 120 are determined in accordance with one or more desired hotel parameters designated by the user.

Thus, it may be seen in FIG. 1B, that if the user designates SIX FLAGS OREGON as a desired travel destination and POOL as a parameter, the user is presented with a proposed cluster of hotels 120 which provides a higher density of hotels with swimming pools.

In the embodiment of FIG. 1B, a pre-set collection of user designatable hotel parameters may be used.

It is appreciated that the system for travel planning of the present invention hotels typically includes interfaces for conventional booking functionality for individual hotels included in the cluster of hotels 120. In accordance with an alternate embodiment of the present invention, the system for travel planning may include a close tie to the booking database enabling the cluster of hotels 120 to only display hotels that are available for a certain date or date range. Alternatively, the system for travel planning may include links to individual hotel websites which the user may follow to complete the hotel booking via the Internet or telephone.

FIG. 1C shows a typical printout which is provided to the user and which may further include advertisements specific to the user selected proposed travel destinations and booked hotels.

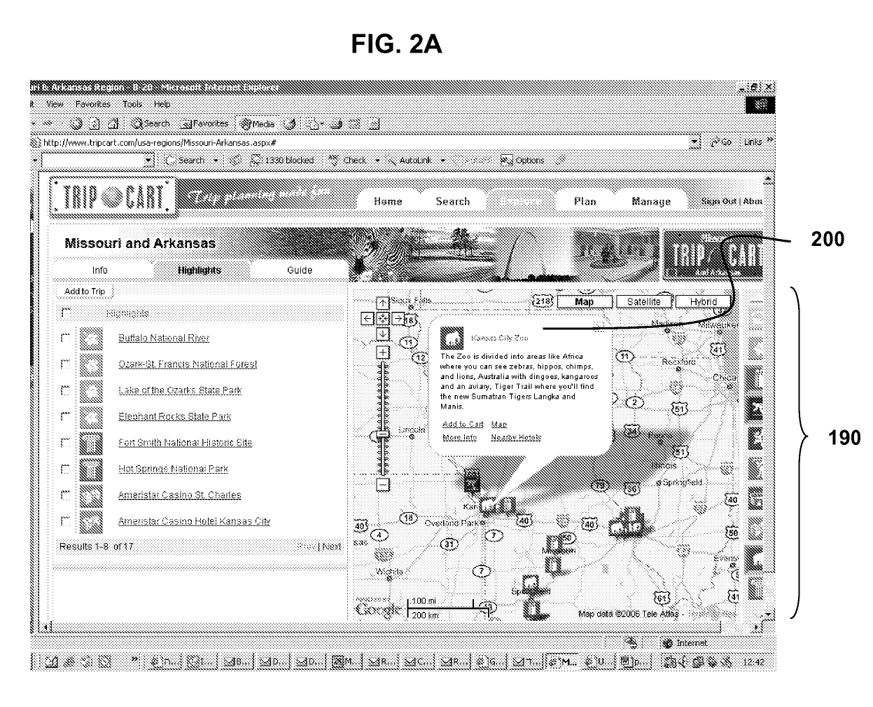

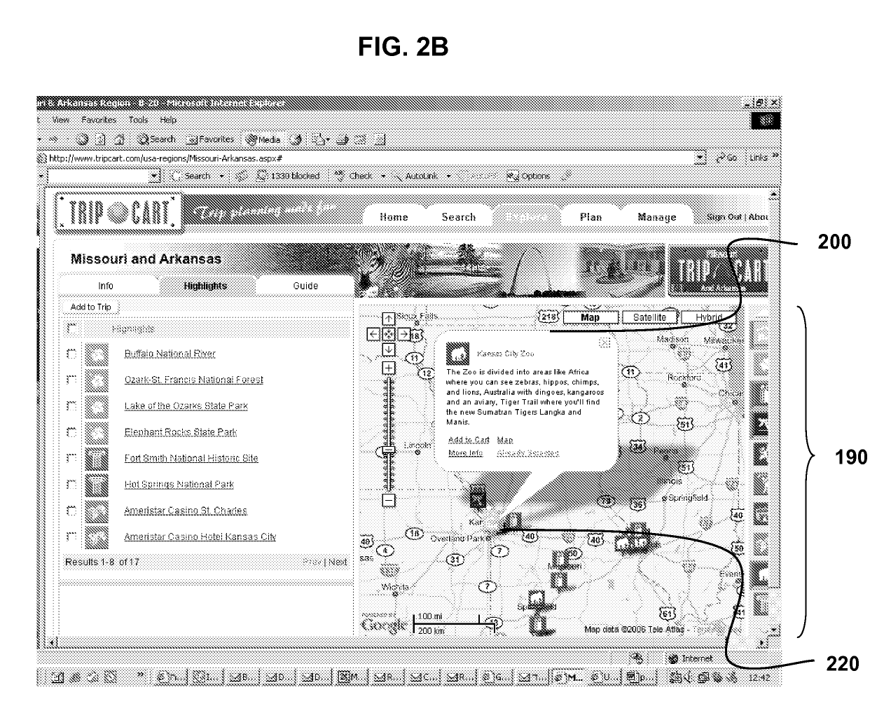

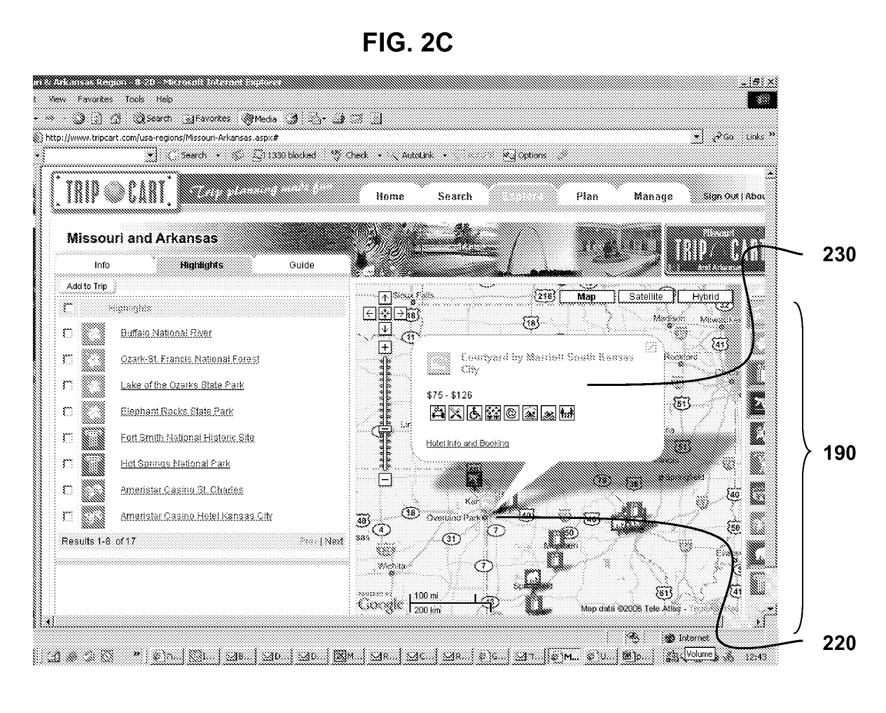

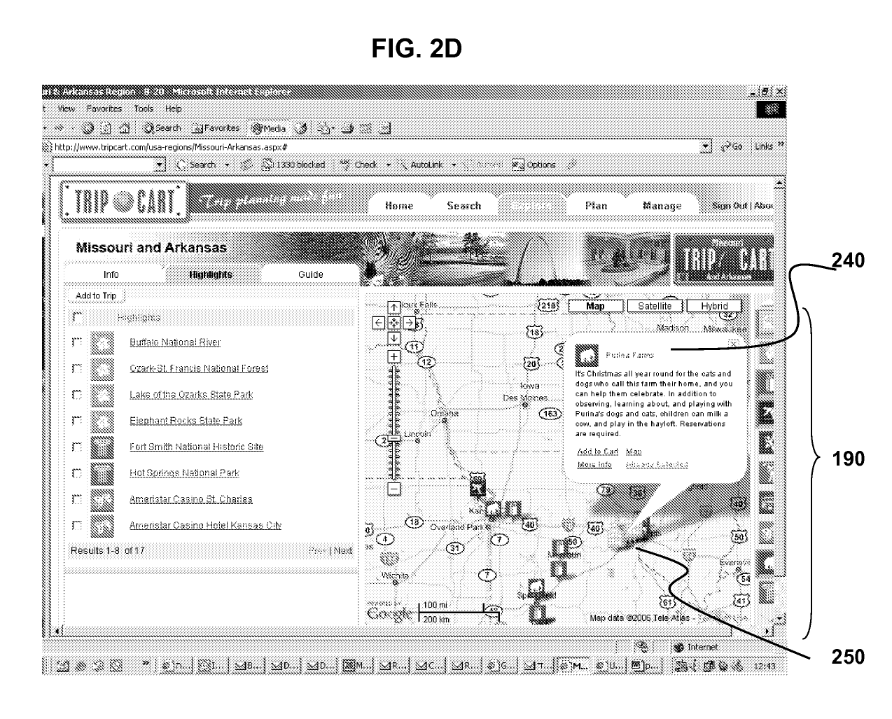

Reference is now made to FIGS. 2A-2D, which are exemplary screen shots illustrating a computer screen as seen by a user at various stages of operation of the present invention.

The first step of an activity based trip planning and hotel booking process typically includes the designation by the user of a first travel destination on an online viewable map 190. Reference is made to FIG. 2A which is an exemplary view of the online viewable map 190 and including at least one designated travel destination 200. In the example of FIG. 2A, the designated travel destination 200 is the “Kansas City Zoo” in the State of Kansas in the United States and a short description thereof may appear on the screen. FIG. 2B is an exemplary view of the online viewable map 190 of FIG. 2A with a cluster of hotels 220 shown thereon in accordance with a preferred embodiment of the present invention.

FIG. 2C is an exemplary view of the online viewable map 190 with a selected hotel 230 designated from the cluster of hotels 220. Details describing the selected hotel 230 including price and other important decision making factors are preferably indicated to provide the user with further decision making tools.

FIG. 2D is an exemplary view of the on line viewable map 190 of FIGS. 2A-2C with a second travel destination 240 designated by the user. It is appreciated that a second cluster of hotels 250 corresponds to the second travel destination 240. It is further appreciated that the visible area of online viewable map 190 may automatically zoom in or zoom out to show a cluster of hotels more clearly and to reflect an optimal size for the number of hotels in the cluster.

Reference is now made to FIG. 3, which is a simplified illustrative diagram of an algorithm employed in accordance with one embodiment of the present invention. The illustrated algorithm is used to define hotel clusters relative to a destination as described hereinabove in accordance with a preferred embodiment of the present invention.

For the purpose of the examples shown herein, a travel destination may be an attraction, an activity, or a place of interest.

The first step of the algorithm includes generation of a comprehensive destination list including geographical coordinates of travel destinations in a geographical area. The destination list may further include parameters characterizing the destination, i.e. family destination, luxury location, cultural, etc.

The second step of the algorithm includes generation of a comprehensive hotel list including geographical coordinates of hotels in a geographical area.

Preferably, the comprehensive hotel list further includes information for each hotel, which may include some or all of the typical price range, location, size, amenities, star rating.

In addition, each hotel on the comprehensive hotel list is typically evaluated in terms of dynamic parameters which may include convenience factors, ranking factors, bookability factors, characterization factors or a combination thereof. Convenience factors may include geographical proximity to the travel destination, convenience of access, special promotions or events occurring therein. Convenience factors may further include traffic or road conditions leading to the hotel. Ranking factors may include popularity among the users of a travel planning site, etc. Bookability factors may include a calculated likelihood-of-conversion factor representing a percentage of users who have previously booked the specific hotel after selecting it from a cluster. Characterization factors may include the type of hotel, e.g. family friendly, luxury, romantic, pet-friendly etc.

The result of the selection by a user of a travel destination and a request to find hotels is typically a cluster including at least one hotel from the comprehensive hotel list. Hotels included in the cluster may be selected by convenience factors, ranking factors, bookability factors or a combination thereof. In one case, a hotel may be removed from a cluster because of low ranking, e.g. poor reviews by other travelers. Alternatively, a relatively distant hotel may be included in a cluster if no other hotels are found in geographic proximity to the selected travel destination.

In accordance with one embodiment of the present invention, the cluster of hotels may be refined based on user specified input, i.e. requested amenities, a specific hotel chain, etc or as otherwise selected from a predefined or dynamic list. In further accordance with one embodiment of the present invention, the cluster of hotels may be refined based on the matching between a characterization of the destination from the destination list and characterization factors of the hotel.

The last step is interfacing to a booking engine to book the hotel as known in the art.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. A method for travel planning employing a computerized database query system, the method comprising:
user designation of at least one desired travel destination; and
system presentation to user of at least one proposed hotel, said at least one proposed hotel being selected for presentation based on general convenience to said travel destination.

2. A method for travel planning according to claim 1 and also comprising:
system presentation to user of a visually sensible graphical map of said at least one proposed travel destination bearing visually sensible indicia corresponding to proposed hotels generally convenient to said travel destination.

3. A method for travel planning according to claim 2 and also comprising:
user designation of amenities; and
system presentation of visually sensible indicia corresponding to said user-designated amenities and convenient to said travel destination.

4. A method for travel planning according to claim 1 and wherein a prepared set of possible desired travel parameters is available for designation by said user to characterize said travel destination.

5. A method for travel planning according to claim 1 and wherein said at least one proposed hotel is selected at least partially to correspond to the desired travel parameters of said travel destination.

6. A method for travel planning according to claim 1 and wherein said at least one proposed hotel is characterized by at least one parameter.

7. A method for travel planning according to claim and wherein said characterizing parameter is user reviews.

8. A system for travel planning comprising:
a graphical user interface operative to enable user designation of at least one desired travel destination;
an interactive computer system responsive to said user designation of a desired travel destination for selecting at least one generally convenient proposed hotel relative to said desired travel destination; and
a display presenting to said user in visually sensible form said at least one proposed hotel.

9. A method for constructing a system for travel planning including:
a graphical user interface operative to enable user designation of at least one desired travel destination;
an interactive computer system responsive to said user designation for indicating at least one proposed hotel; and
a display presenting to said user in visually sensible form said at least one proposed hotel,
the method comprising:
designating a plurality of desired travel destinations;
designating a plurality of hotels;
for said plurality of desired travel destinations, selecting a multiplicity of proposed hotels in proximity thereof;
preparing information relating to at least one of said at multiplicity of proposed hotels for presentation to said user on said display in visually sensible form.

10. A method for constructing a system for travel planning according to claim 9 and further including filtering said multiplicity of proposed hotels based on convenience factors.

11. A method for constructing a system for travel planning according to claim 10 and wherein said convenience factors include geographical considerations.

12. A method for constructing a system for travel planning according to claim 10 and wherein said convenience factors include traffic considerations.

13. A method for constructing a system for travel planning according to claim 9 and further including filtering said multiplicity of proposed hotels based on ranking factors.

14. A method for constructing a system for travel planning according to claim 13 and wherein said ranking factors include reviews from at least one external user.
